(19) United States
(12) Patent Application Publication
(10) Pub. No.: US 2015/0170012 A1
(43) Pub. Date: Jun. 18, 2015

(54) PRINT CONTROL APPARATUS AND NON-TRANSITORY COMPUTER READABLE MEDIUM

(71) Applicant: FUJI XEROX CO., LTD., Tokyo (JP)

(72) Inventors: Masayuki IWASAWA, Kanagawa (JP); Issei MATSUSHITA, Kanagawa (JP); Shingo KATO, Kanagawa (JP); Yutaka KOJIMA, Kanagawa (JP); Hiroo YOSHIDA, Kanagawa (JP); Naoki YASUDA, Kanagawa (JP); Shinichi TAKANO, Kanagawa (JP); Taro YAMAZAKI, Kanagawa (JP)

(73) Assignee: FUJI XEROX CO., LTD., Tokyo (JP)

(21) Appl. No.: 14/258,725

(22) Filed: Apr. 22, 2014

(30) Foreign Application Priority Data
Dec. 17, 2013 (JP) 2013-260539

(51) Int. Cl. G06K 15/00; G06K 15/02

(52) U.S. Cl. CPC G06K 15/4065; G06K 15/02

(57) ABSTRACT

A print control apparatus includes a specifying-information acquisition unit, a first acquisition unit, an attribute recognition unit, a second acquisition unit, and a controller. The specifying-information acquisition unit acquires first specifying information specifying a certain supply section that is to supply a medium or second specifying information specifying that a printer determine a supply section that is to supply the medium on the basis of an attribute of the medium. The first acquisition unit acquires, when the first specifying information is acquired, first setting information associated with a certain process included in a printing process. The attribute recognition unit recognizes an attribute of the medium when the second specifying information is acquired. The second acquisition unit acquires second setting information set for the attribute. The controller performs control such that the printing process is performed by the printer on the basis of the first or second setting information.

### CROSS-REFERENCE TO RELATED APPLICATIONS

This application is based on and claims priority under 35 USC 119 from Japanese Patent Application No. 2013-260539 filed Dec. 17, 2013.

### BACKGROUND

### Technical Field

The present invention relates to a print control apparatus and a non-transitory computer readable medium.

### SUMMARY

According to an aspect of the invention, there is provided a print control apparatus including a specifying-information acquisition unit, a first setting-information acquisition unit, an attribute recognition unit, a second setting-information acquisition unit, and a controller. The specifying-information acquisition unit acquires either of first specifying information and second specifying information, the first specifying information specifying a certain supply section that is to supply a medium to be used in a printing process from among plural supply sections of a printer, the second specifying information specifying that the printer determine a supply section that is to supply the medium from among the plural supply sections on the basis of an attribute of the medium. The first setting-information acquisition unit acquires, in a case where the first specifying information has been acquired by the specifying-information acquisition unit, first setting information associated with a certain process included in the printing process set for the certain supply section. The attribute recognition unit recognizes an attribute of the medium in a case where the second specifying information has been acquired by the specifying-information acquisition unit. The second setting-information acquisition unit acquires second setting information set for the attribute of the medium recognized by the attribute recognition unit, the second setting information being associated with the certain process. The controller performs control such that, in a case where the first specifying information has been acquired by the specifying-information acquisition unit, the printing process is performed by the printer on the basis of the first setting information acquired by the first setting-information acquisition unit and, in a case where the second specifying information has been acquired by the specifying-information acquisition unit, the printing process is performed by the printer on the basis of the second setting information acquired by the second setting-information acquisition unit.

### BRIEF DESCRIPTION OF THE DRAWINGS

An exemplary embodiment of the present invention will be described in detail based on the following figures, wherein:

FIG. 1 is a diagram illustrating an example of an overall configuration of a printing system in the exemplary embodiment of the invention;

FIG. 2 is a diagram illustrating an example of print setting information stored in a setting memory within a computer in the exemplary embodiment of the invention;

FIG. 3 is a diagram illustrating an example of a setting screen displayed by a user interface unit within the computer in the exemplary embodiment of the invention;

FIG. 4 is a block diagram illustrating an example of a functional configuration of a control-code generation unit within the computer in the exemplary embodiment of the invention;

FIG. 5 is a flowchart illustrating an example of an operation of the control-code generation unit within the computer in the exemplary embodiment of the invention;

FIG. 6 is a diagram illustrating a method applicable to the case where an issue arises when automatic selection of a sheet supply section is specified for the printer which may set, for all the sheet supply sections, a single setting as to whether or not to perform 180° rotation printing; and

FIG. 7 is a diagram illustrating an example of a hardware configuration of a computer in the exemplary embodiment of the invention.

### DETAILED DESCRIPTION

In the following, an exemplary embodiment of the invention will be described in detail with reference to attached drawings.

Configuration of Exemplary Embodiment

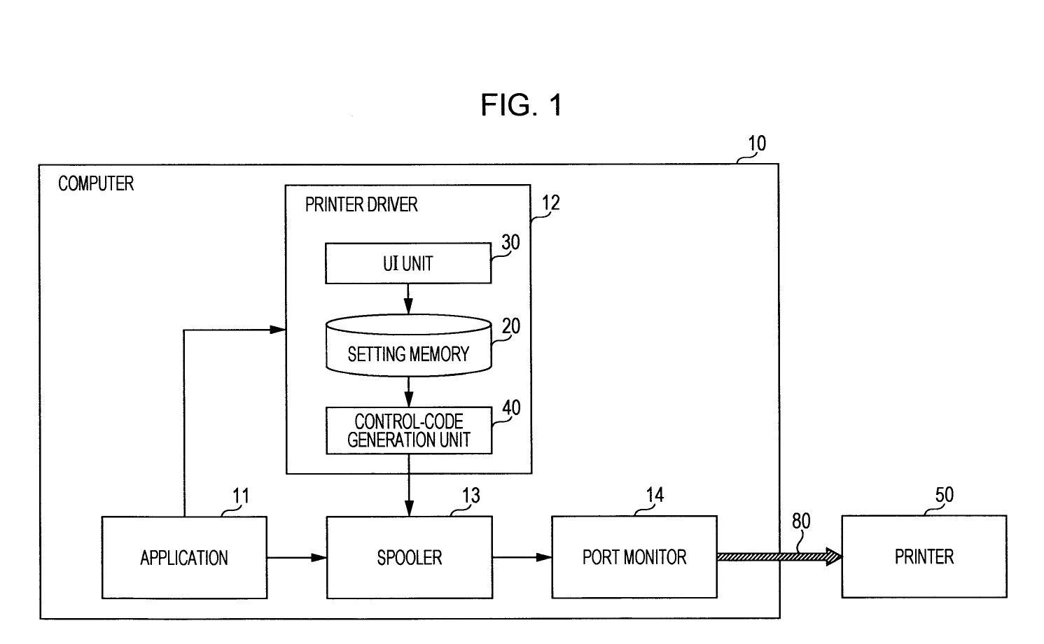

FIG. 1 is a diagram illustrating an example of the entire configuration of a printing system in the exemplary embodiment. As illustrated in FIG. 1, this printing system is configured by connecting a computer 10 with a printer 50 via a network 80. Here, only one printer 50 is illustrated; however, the number of printers 50 is not limited to one.

The computer 10 is an example of a print control apparatus, and commands printing to be performed by the printer 50 by transmitting, to the printer 50, print data to be used in printing and a control code for controlling printing. Specifically, the computer 10 includes an application program (hereinafter simply referred to as an “application”) 11 and a printer driver 12, a spooler 13, and a port monitor 14.

The application 11 invokes the printer driver 12 when a user performs a print operation. In addition, when output of print data is requested by the spooler 13, the print data is output to the spooler 13 through, for example, Graphics Device Interface (GDI).

The printer driver 12 generates a control code for controlling printing to be performed by the printer 50 and requests printing by outputting the control code to the spooler 13. The printer driver 12 is also an example of the print control apparatus.

Upon receiving a print request from the printer driver 12, the spooler 13 performs spooling on print data received from the application 11 through, for example, GDI and outputs, to the port monitor 14, the print data on which spooling has been performed and the control code received from the printer driver 12. In the exemplary embodiment, print data is used as an example of print information and the spooler 13 is provided as an example of a print information acquisition unit that acquires print information.

The port monitor 14 transmits the print data and control code received from the spooler 13 to the printer 50 via a communication protocol defined in the printer 50. In the exemplary embodiment, control codes are used as examples of first control information and second control information and the port monitor 14 is provided as an example of a transmission unit that transmits print information and the first or second control information.

Here, the printer driver 12 will be described in more detail. The printer driver 12 includes a setting memory 20, a user interface (UI) unit 30, and a control-code generation unit 40. In other words, when the printer driver 12 operates, the setting memory 20, the UI unit 30, and the control-code generation unit 40 are realized in the computer 10.

The setting memory 20 stores information on settings associated with printing to be performed by the printer 50 (hereinafter referred to as “print setting information”). This print setting information will be described in detail later.

The UI unit 30 is an example of a display controller, and displays a setting screen serving as a UI of the printer driver 12. In the case where the setting screen is displayed before or after printing is started by the application 11, print setting information is read from the setting memory 20 and reflected on the setting screen. In the case where a change has been made to the settings on this setting screen, print setting information obtained after the change is stored in the setting memory 20.

The control-code generation unit 40 generates a control code for controlling printing to be performed by the printer 50. In this case, the control-code generation unit 40 reads print setting information from the setting memory 20 and reflects the print setting information on generation of a control code. Thereafter, the control-code generation unit 40 issues a print request to the spooler 13.

Upon receiving print data and a control code from the computer 10, the printer 50 prints an image based on the print data on a recording medium such as a sheet in accordance with the control code.

The network 80 is used to communicate information between the computer 10 and the printer 50, and an example of the network 80 is a local area network (LAN).

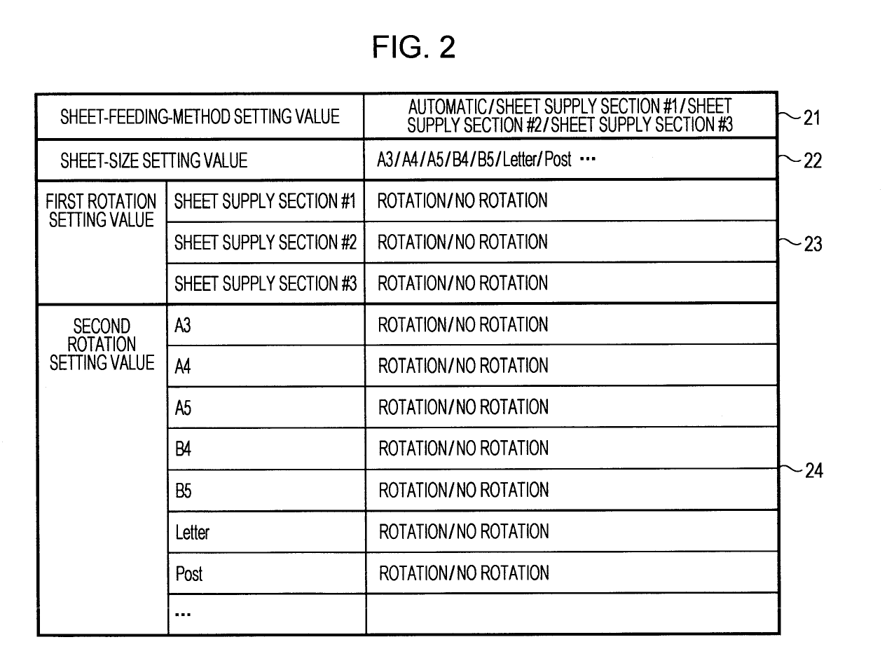

FIG. 2 is a diagram illustrating an example of print setting information stored in the setting memory 20 illustrated in FIG. 1. More specifically, as illustrated in FIG. 2, the setting memory 20 stores a sheet-feeding-method setting value 21, a sheet-size setting value 22, a first rotation setting value 23, and a second rotation setting value 24.

The sheet-feeding-method setting value 21 is a setting value associated with a sheet feeding method. As the sheet-feeding-method setting value 21, a setting value is stored that is selected from among a setting value “automatic” indicating sheet supply from a sheet supply section in which sheets of a sheet size indicated by the sheet-size setting value 22 are set, a setting value “SHEET SUPPLY SECTION #1” indicating sheet supply from a sheet supply section #1, a setting value “SHEET SUPPLY SECTION #2” indicating sheet supply from a sheet supply section #2, a setting value “SHEET SUPPLY SECTION #3” indicating sheet supply from a sheet supply section #3, and the like.

The sheet-size setting value 22 is a setting value associated with a sheet size. As the sheet-size setting value 22, a setting value is stored that is selected from among setting values indicating A3, A4, A5, B4, B5, Letter, Post, and the like.

For each sheet supply section, the first rotation setting value 23 is a setting value as to whether or not to perform 180° rotation printing for the sheet supply section. For each sheet supply section, a setting value is stored that is selected as the first rotation setting value 23 from among a setting value “ROTATION” indicating that 180° rotation printing is performed and a setting value “NO ROTATION” indicating that 180° rotation printing is not performed.

For each sheet size, the second rotation setting value 24 is a setting value as to whether or not to perform 180° rotation printing for the sheet size. For each sheet size, a setting value is stored that is selected as the second rotation setting value 24 from among a setting value “ROTATION” indicating that 180° rotation printing is performed and a setting value “NO ROTATION” indicating that 180° rotation printing is not performed. That is, for all the sheet sizes defined in the sheet-size setting value 22, individual setting values are prepared as to whether or not to perform 180° rotation printing.

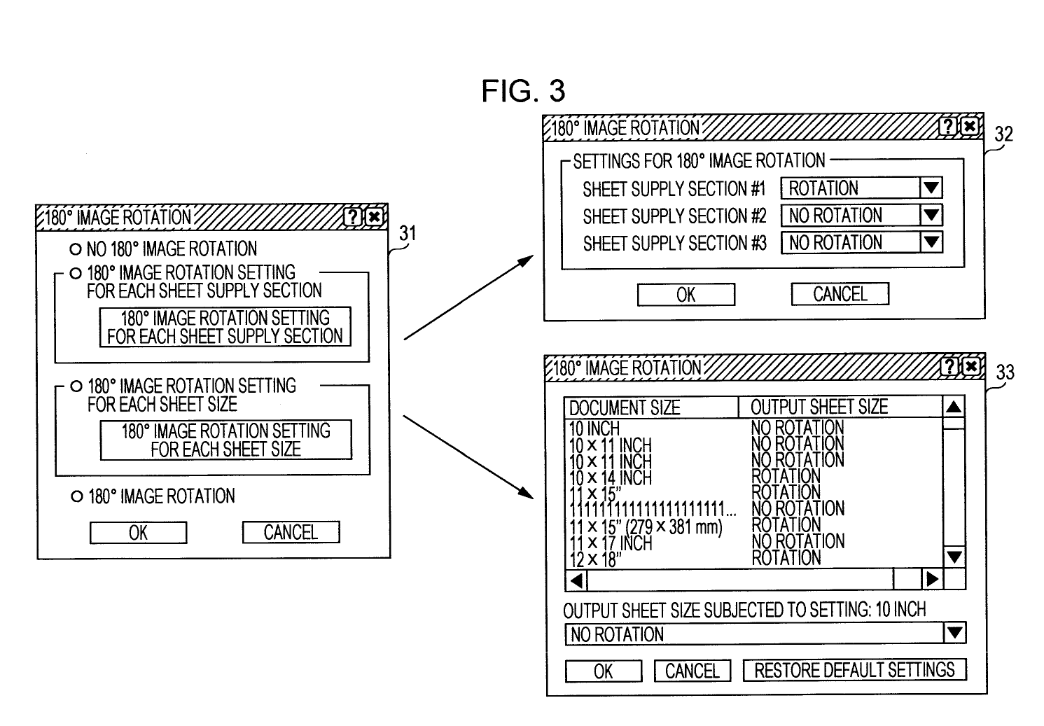

FIG. 3 is a diagram illustrating an example of a setting screen displayed by the UI unit 30 illustrated in FIG. 1. More specifically, as illustrated in FIG. 3, the UI unit 30 displays a rotation-setting selection screen 31, a first rotation setting screen 32, and a second rotation setting screen 33. The rotation-setting selection screen 31 is an example of a specifying screen. The first rotation setting screen 32 is an example of a first setting screen. The second rotation setting screen 33 is an example of a second setting screen. In the case where “180° image rotation setting for each sheet supply section” is selected on the rotation-setting selection screen 31, the first rotation setting screen 32 is activated to set, for each sheet supply section, a rotation setting. For each sheet supply section, “ROTATION” or “NO ROTATION” may be specified. In the case where “180° image rotation setting for each sheet size” is selected on the rotation-setting selection screen 31, the second rotation setting screen 33 is activated to set, for each sheet size, a rotation setting. For each sheet size, “ROTATION” or “NO ROTATION” may be specified.

Configuration of Control-Code Generation Unit

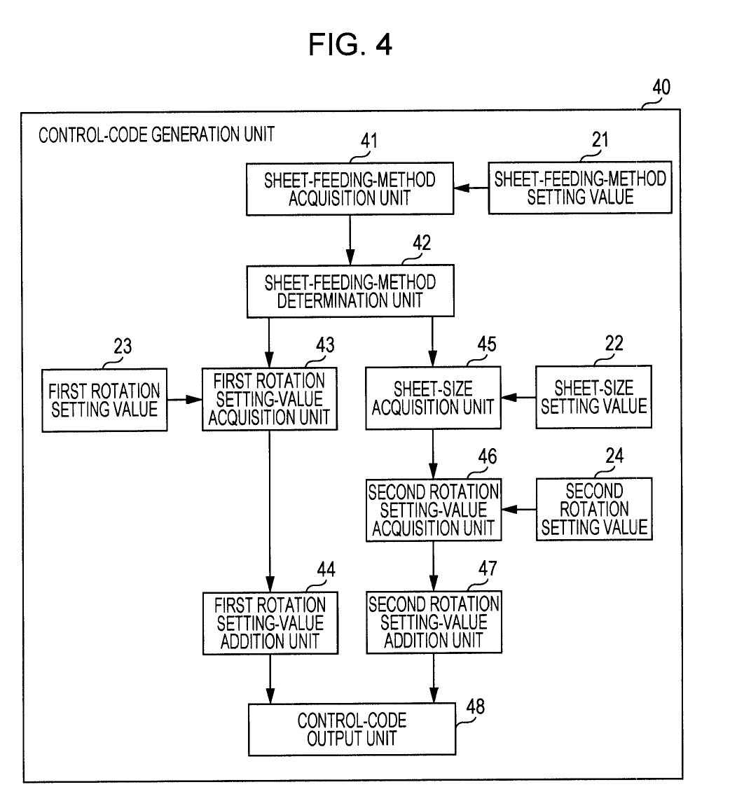

FIG. 4 is a block diagram illustrating an example of a functional configuration of the control-code generation unit 40 illustrated in FIG. 1. As illustrated in FIG. 4, the control-code generation unit 40 includes a sheet-feeding-method acquisition unit 41, a sheet-feeding-method determination unit 42, a first rotation setting-value acquisition unit 43, a first rotation setting-value addition unit 44, a sheet-size acquisition unit 45, a second rotation setting-value acquisition unit 46, a second rotation setting-value addition unit 47, and a control-code output unit 48. In addition, FIG. 4 also illustrates the setting values illustrated in FIG. 2 included in the print setting information stored in the setting memory 20.

The sheet-feeding-method acquisition unit 41 acquires either of the sheet-feeding-method setting value 21 specifying a sheet supply section and the sheet-feeding-method setting value 21 indicating automatic selection. Thereafter, the sheet-feeding-method acquisition unit 41 outputs the sheet-feeding-method setting value 21 to the sheet-feeding-method determination unit 42. In the exemplary embodiment, the sheet-feeding-method setting value 21 specifying a sheet supply section is an example of first specifying information, the sheet-feeding-method setting value 21 indicating automatic selection is an example of second specifying information, and the sheet-feeding-method acquisition unit 41 is provided as an example of a specifying-information acquisition unit that acquires either of the first specifying information and the second specifying information.

The sheet-feeding-method determination unit 42 determines which one of the sheet-feeding-method setting value 21 specifying a sheet supply section and the sheet-feeding-method setting value 21 indicating automatic selection the sheet-feeding-method determination unit 42 has received from the sheet-feeding-method acquisition unit 41. In the case where it is determined that the sheet-feeding-method determination unit 42 has received the sheet-feeding-method setting value 21 specifying a sheet supply section, the sheet-feeding-method determination unit 42 starts up the first rotation setting-value acquisition unit 43 and outputs the sheet-feeding-method setting value 21 to the first rotation setting-value acquisition unit 43. In the case where it is determined that the sheet-feeding-method determination unit 42 has received the sheet-feeding-method setting value 21 indicating automatic selection, the sheet-feeding-method determination unit 42 starts up the second rotation setting-value acquisition unit 46 and outputs the sheet-feeding-method setting value 21 to the second rotation setting-value acquisition unit 46.

Upon receiving the sheet-feeding-method setting value 21 from the sheet-feeding-method determination unit 42, the first rotation setting-value acquisition unit 43 acquires the first rotation setting value 23 corresponding to the sheet supply section specified by the sheet-feeding-method setting value 21. Thereafter, the first rotation setting-value acquisition unit 43 outputs the sheet-feeding-method setting value 21 and the first rotation setting value 23 to the first rotation setting-value addition unit 44. In the exemplary embodiment, the first rotation setting value 23 is used as an example of first setting information, and the first rotation setting-value acquisition unit 43 is provided as an example of a first setting-information acquisition unit that acquires the first setting information.

The first rotation setting-value addition unit 44 adds, to a control code, the sheet-feeding-method setting value 21 and the first rotation setting value 23 received from the first rotation setting-value acquisition unit 43. Thereafter, the first rotation setting-value addition unit 44 outputs the control code to the control-code output unit 48. In the exemplary embodiment, the first rotation setting-value addition unit 44 is provided as an example of a first generation unit that generates first control information including the first specifying information and the first setting information.

Upon receiving the sheet-feeding-method setting value 21 from the sheet-feeding-method determination unit 42, the sheet-size acquisition unit 45 acquires the sheet-size setting value 22. Thereafter, the sheet-size acquisition unit 45 outputs the sheet-feeding-method setting value 21 and the sheet-size setting value 22 to the second rotation setting-value acquisition unit 46. Here, a sheet size is not limited to a size indicated by the sheet-size setting value 22. A sheet size may also be recognized, for example, on the basis of document data to be subjected to printing or the like. In the exemplary embodiment, a sheet size is used as an example of an attribute of a medium, and the sheet-size acquisition unit 45 is provided as an example of an attribute recognition unit that recognizes the attribute of the medium.

The second rotation setting-value acquisition unit 46 acquires the second rotation setting value 24 corresponding to the sheet-size setting value 22 received from the sheet-size acquisition unit 45. Thereafter, the second rotation setting-value acquisition unit 46 outputs the sheet-feeding-method setting value 21, the sheet-size setting value 22, and the second rotation setting value 24 to the second rotation setting-value addition unit 47. In the exemplary embodiment, the second rotation setting value 24 is used as an example of second setting information, and the second rotation setting-value acquisition unit 46 is provided as an example of a second setting-information acquisition unit that acquires the second setting information.

The second rotation setting-value addition unit 47 adds, to a control code, the sheet-feeding-method setting value 21, the sheet-size setting value 22, and the second rotation setting value 24 received from the second rotation setting-value acquisition unit 46. Thereafter, the second rotation setting-value addition unit 47 outputs the control code to the control-code output unit 48. In the exemplary embodiment, the second rotation setting-value addition unit 47 is provided as an example of a second generation unit that generates second control information including the second specifying information, the attribute of the medium, and the second setting information.

The control-code output unit 48 outputs, to the spooler 13, the control code received from the first rotation setting-value addition unit 44 or the control code received from the second rotation setting-value addition unit 47. In the exemplary embodiment, the control-code output unit 48 is provided as an example of a controller that performs control such that a printing process is performed by a printer on the basis of the first setting information in the case where the first specifying information has been acquired and on the basis of the second setting information in the case where the second specifying information has been acquired.

Operation of Control-Code Generation Unit

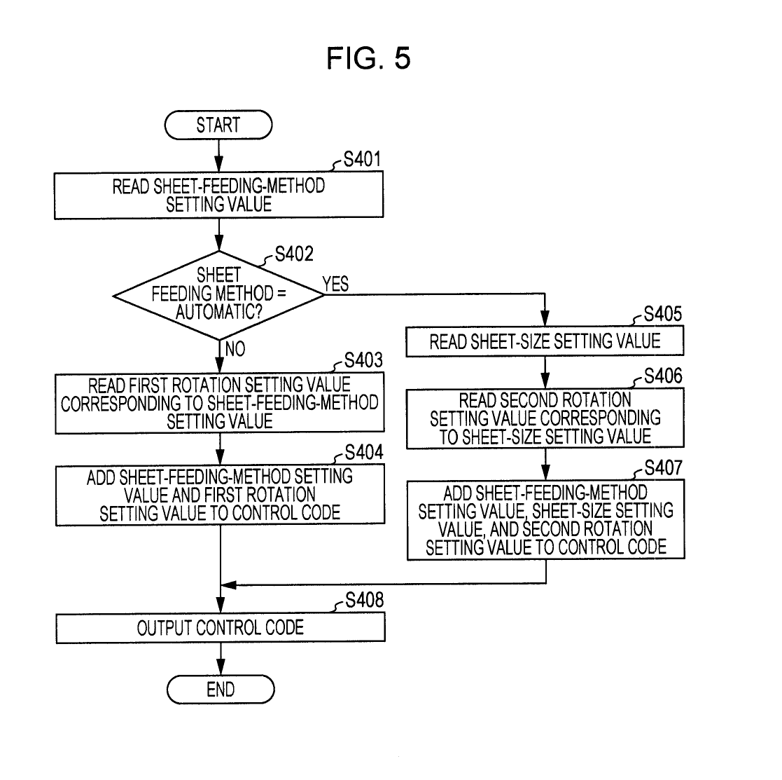

FIG. 5 is a flowchart illustrating an example of an operation of the control-code generation unit 40 illustrated in FIG. 1.

As illustrated in FIG. 5, in the control-code generation unit 40, the sheet-feeding-method acquisition unit 41 first reads the sheet-feeding-method setting value 21 from the setting memory 20 (step S401).

Next, the sheet-feeding-method determination unit 42 determines whether or not the sheet-feeding-method setting value 21 read in step S401 is “automatic” (step S402). Here, “automatic” refers to a setting value indicating that the printer 50 is caused to select a sheet supply section in which sheets of a specified sheet size are set, as described above.

As a result, suppose that the sheet-feeding-method setting value 21 read in step S401 is not “automatic”. In this case, the sheet-feeding-method setting value 21 read in step S401 is a setting value specifying a sheet supply section. Thereafter, the first rotation setting-value acquisition unit 43 reads the first rotation setting value 23 corresponding to the sheet-feeding-method setting value 21 from the setting memory 20 (step S403).

Next, the first rotation setting-value addition unit 44 adds, to a control code, the sheet-feeding-method setting value 21 read in step S401 and the first rotation setting value 23 read in step S403 (step S404).

In contrast, suppose that the sheet-feeding-method setting value 21 read in step S401 is “automatic”. In this case, the sheet-size acquisition unit 45 reads the sheet-size setting value 22 from the setting memory 20 (step S405).

Next, the second rotation setting-value acquisition unit 46 reads, from the setting memory 20, the second rotation setting value 24 corresponding to the sheet-size setting value 22 read in step S405 (step S406).

Next, the second rotation setting-value addition unit 47 adds, to a control code, the sheet-feeding-method setting value 21 read in step S401, the sheet-size setting value 22 read in step S405, and the second rotation setting value 24 read in step S406 (step S407).

Thereafter, the control-code output unit 48 outputs, to the spooler 13, the control code to which the sheet-feeding-method setting value 21 and the first rotation setting value 23 have been added in step S404 or the control code to which the sheet-feeding-method setting value 21, the sheet-size setting value 22, and the second rotation setting value 24 have been added in step S407 (step S408).

Operation of Exemplary Embodiment

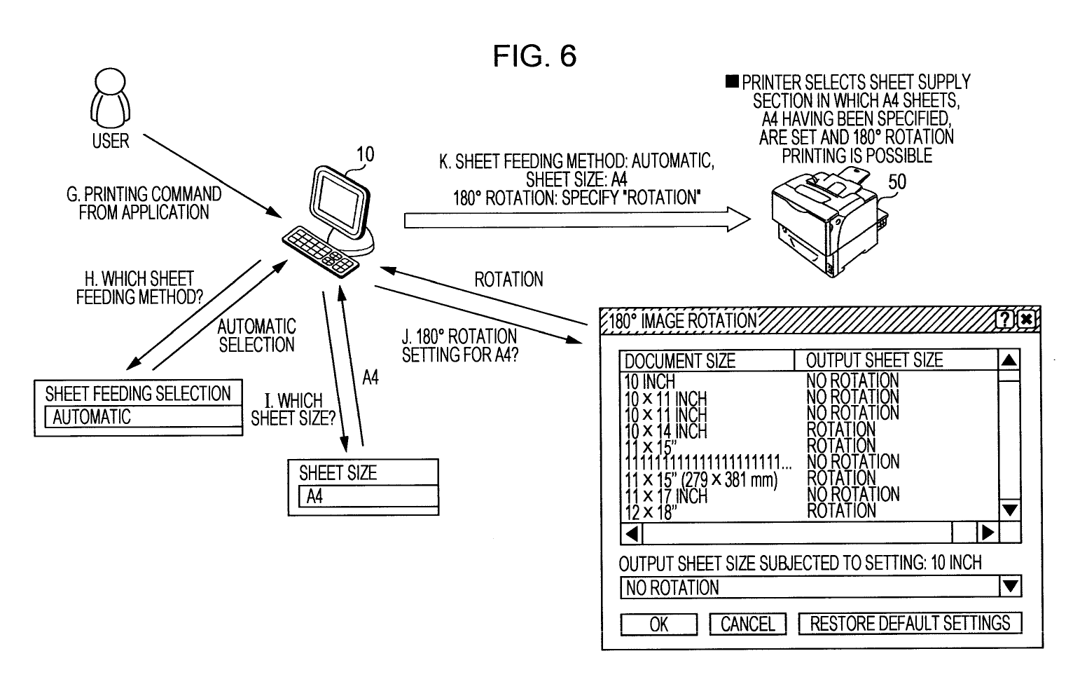

FIG. 6 illustrates a method applicable to the case where an issue arises when automatic selection of a sheet supply section is specified as a sheet feeding method in the printer driver in a method used to improve user-friendliness of the printer 50 which may set, for all the sheet supply sections, a single setting as to whether or not to perform 180° rotation printing. In this case, a user first starts an application on the computer 10, sets settings as to a sheet feeding method, a sheet size, whether or not 180° rotation is performed, and the like through the setting screen of the printer driver (see FIG. 3), and commands printing from the application (“G” in FIG. 6). Thereafter, the printer driver reads the print setting information (see FIG. 2) in a sequential manner from the setting memory 20 in accordance with the flowchart illustrated in FIG. 5. Specifically, first, the sheet feeding method is checked and it is determined that automatic selection has been set (“H” in FIG. 6). Next, the sheet size is checked and the sheet size that is currently specified is determined (“I” in FIG. 6). Next, whether or not to perform 180° rotation printing at the time of printing on sheets of the sheet size determined in “I” is determined by referring to the individual settings as to whether or not to perform 180° rotation printing for the sheet supply sections prepared in advance (“J” in FIG. 6). As a result, in the case where printing is performed by the printer 50 which may set, for all the sheet supply sections, a single setting as to whether or not to perform 180° rotation printing, even when automatic selection of a sheet supply section is specified as a sheet feeding method in the printer driver, the computer 10 may add information as to whether or not to perform 180° rotation printing to print data and output the print data to the printer 50 (“K” in FIG. 6).

Hardware Configuration of Computer

In the exemplary embodiment, the computer 10 performs a process to realize the method illustrated in FIG. 6; however, such a process may also be performed by a controller of the printer 50 or may also be performed by a print server (not illustrated) which makes it possible to use the printer 50 from plural computers 10. In the former case, the controller of the printer 50 is an example of the print control apparatus, and in the latter case, the print server is an example of the print control apparatus. Such a process is generalized to a process to be performed by a computer 90, and a hardware configuration of the computer 90 will be described.

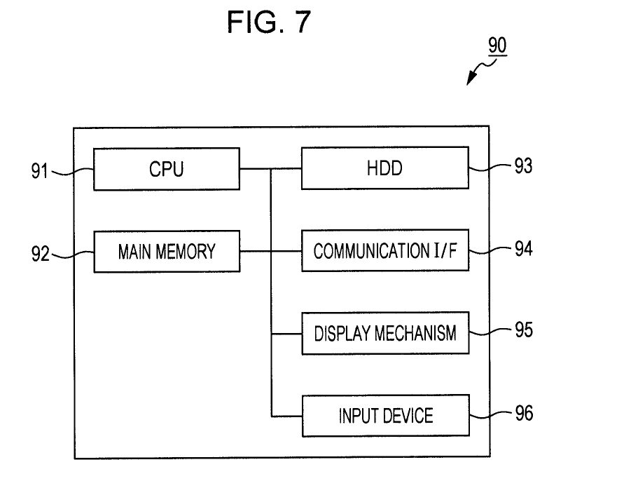

FIG. 7 is a diagram illustrating a hardware configuration of the computer 90. As illustrated in FIG. 7, the computer 90 includes a central processing unit (CPU) 91 serving as an arithmetic unit, and a main memory 92 and a magnetic disk device (HDD) 93 serving as a memory. Here, the CPU 91 executes various software programs such as an operating system (OS) and applications, and realizes processing units, which will be described later. In addition, the main memory 92 stores various software programs and data and the like to be used for execution of the software programs. The magnetic disk device 93 stores input data for various software programs, output data from various software programs, and the like. The main memory 92, the magnetic disk device 93, or both realize the above-described setting memory 20.

Furthermore, the computer 90 includes a communication interface (I/F) 94 for communication to and from the outside, a display mechanism 95 including a video memory and a display, and an input device 96 such as a keyboard, a mouse, and the like.

### Modified Example

In the exemplary embodiment, automatic selection of a sheet supply section refers to a case where the printer driver 12 specifies a sheet size and the printer 50 feeds sheets from a sheet supply section in which sheets of the specified sheet size are set. In the case where automatic selection has been specified as the sheet feeding method, the printer driver 12 acquires the sheet-size setting value 22; however, a value acquired by the printer driver 12 is not limited to this.

For example, automatic selection of a sheet supply section may refer to a case where the printer driver 12 specifies a sheet type (a normal sheet, a thick sheet, an OHP film, or the like) and the printer 50 feeds sheets from a sheet supply section in which sheets of the specified sheet type are set. In the case where automatic selection has been specified as the sheet feeding method, the printer driver 12 may also acquire a setting value of a sheet type. As a result of generalization of this case, in the case where automatic selection has been specified as a sheet feeding method, the printer driver 12 may also acquire a setting value associated with some kind of attribute of sheets.

In addition, for each sheet supply section and each sheet size, whether or not to perform 180° rotation printing is set in the exemplary embodiment; however, a setting is not limited to this.

For example, for each sheet supply section and each sheet size, single side printing or both side printing may also be set, the position of a binding margin in both side printing (long edge binding or short edge binding) may also be set, and a printing position on a sheet may also be set. In addition, as a result of generalization of this case, individual settings associated with image processing to be performed on an image, which is a print target, may also be set for the sheet supply sections or the sheet sizes.

In addition, since some printers 50 have plural sheet ejecting slots such as a sheet ejecting slot of the main body and a sheet ejecting slot of a finisher, individual settings as to which sheet ejecting slot is to be used may also be set for the sheet supply sections and sheet sizes. In addition, as a result of generalization of this case, individual settings associated with sheet transportation processing may also be set for the sheet supply sections or the sheet sizes.

Furthermore, for the sheet supply sections and the sheet sizes, individual settings as to the position of staples (no staple, one-staple binding at an upper left corner, one-staple binding at an upper right corner, one-staple binding along an upper side, two-staple binding along a left side, and the like) or individual settings as to the position of holes (no holes, two holes along an upper side, two holes along a right side, two holes along a left side, and the like) may also be set. In addition, as a result of generalization of this case, for the sheet supply sections or the sheet sizes, individual settings associated with post-processing to be performed on sheets (a process performed through a finisher function) may also be set.

Furthermore, as a result of generalization of this case, for the sheet supply sections or the sheet sizes, individual settings associated with some kind of processing in a printing process may also be set.

In addition, in the case where automatic selection has been specified as the sheet feeding method, the printer driver 12 acquires a setting value associated with some kind of attribute of sheets and may set, for the sheet supply sections or the sheet sizes, individual settings associated with some kind of processing in the printing process.

In addition, in the exemplary embodiment, the case has been described where the exemplary embodiment is applied to the printer 50 which may set, for all the sheet supply sections, a single setting as to whether or not to perform 180° rotation printing; however, application of the exemplary embodiment is not limited to this case. The exemplary embodiment may also be applied to a printer driver of the printer 50 which may set, for the sheet supply sections, individual settings as to whether or not to perform 180° rotation printing.

Note that a program that realizes the exemplary embodiment may be provided through a communication unit and may also be stored in a recording medium such as a CD-ROM and provided.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A print control apparatus comprising:
a specifying-information acquisition unit that acquires either of first specifying information and second specifying information, the first specifying information specifying a certain supply section that is to supply a medium to be used in a printing process from among a plurality of supply sections of a printer, the second specifying information specifying that the printer determine a supply section that is to supply the medium from among the plurality of supply sections on the basis of an attribute of the medium;
a first setting-information acquisition unit that acquires, in a case where the first specifying information has been acquired by the specifying-information acquisition unit, first setting information associated with a certain process included in the printing process set for the certain supply section;
an attribute recognition unit that recognizes an attribute of the medium in a case where the second specifying information has been acquired by the specifying-information acquisition unit;
a second setting-information acquisition unit that acquires second setting information set for the attribute of the medium recognized by the attribute recognition unit, the second setting information being associated with the certain process; and
a controller that performs control such that, in a case where the first specifying information has been acquired by the specifying-information acquisition unit, the printing process is performed by the printer on the basis of the first setting information acquired by the first setting-information acquisition unit and, in a case where the second specifying information has been acquired by the specifying-information acquisition unit, the printing process is performed by the printer on the basis of the second setting information acquired by the second setting-information acquisition unit.

2. The print control apparatus according to claim 1, further comprising:
a display controller that performs control such that, after a specifying screen for specifying which of a first operation for setting the first setting information for the certain supply section and a second operation for setting the second setting information for the attribute of the medium is to be performed is displayed on a display, a first setting screen used to set the first setting information is displayed on the display in a case where it has been specified on the specifying screen that the first operation is to be performed, and a second setting screen used to set the second setting information is displayed on the display in a case where it has been specified on the specifying screen that the second operation is to be performed, wherein
the first setting-information acquisition unit acquires the first setting information set on the first setting screen, and
the second setting-information acquisition unit acquires the second setting information set on the second setting screen.

3. The print control apparatus according to claim 1, wherein the attribute of the medium is an attribute associated with at least one of a size of the medium and a type of the medium.

4. The print control apparatus according to claim 2, wherein the attribute of the medium is an attribute associated with at least one of a size of the medium and a type of the medium.

5. The print control apparatus according to claim 1, wherein the certain process is a process including at least one of image processing to be performed on an image, which is a print target, transportation processing to be performed on the medium, and post-processing to be performed on the medium.

6. The print control apparatus according to claim 2, wherein the certain process is a process including at least one of image processing to be performed on an image, which is a print target, transportation processing to be performed on the medium, and post-processing to be performed on the medium.

7. A print control apparatus comprising:
a specifying-information acquisition unit that acquires either of first specifying information and second specifying information, the first specifying information specifying a certain supply section that is to supply a medium to be used in a printing process from among a plurality of supply sections of a printer, the second specifying information specifying that the printer determine a supply section that is to supply the medium from among the plurality of supply sections on the basis of an attribute associated with a size of the medium;
a first setting-information acquisition unit that acquires, in a case where the first specifying information has been acquired by the specifying-information acquisition unit, first setting information indicating whether or not an image, which is a print target, set for the certain supply section is to be rotated by 180°;
an attribute recognition unit that recognizes the attribute associated with the size of the medium in a case where the second specifying information has been acquired by the specifying-information acquisition unit;
a second setting-information acquisition unit that acquires second setting information indicating whether or not an image, which is a print target, set for the attribute associated with the size of the medium is to be rotated by 180°, the attribute having been recognized by the attribute recognition unit; and
a controller that performs control such that, in a case where the first specifying information has been acquired by the specifying-information acquisition unit, the printing process is performed by the printer on the basis of the first setting information acquired by the first setting-information acquisition unit and, in a case where the second specifying information has been acquired by the specifying-information acquisition unit, the printing process is performed by the printer on the basis of the second setting information acquired by the second setting-information acquisition unit.

8. A print control apparatus comprising:
a print information acquisition unit that acquires print information to be used in a printing process by a printer;
a specifying-information acquisition unit that acquires either of first specifying information and second specifying information, the first specifying information specifying a certain supply section that is to supply a medium to be used in the printing process from among a plurality of supply sections of the printer, the second specifying information specifying that the printer determine a supply section that is to supply the medium from among the plurality of supply sections on the basis of an attribute of the medium;
a first setting-information acquisition unit that acquires, in a case where the first specifying information has been acquired by the specifying-information acquisition unit, first setting information associated with a certain process included in the printing process set for the certain supply section;
a first generation unit that generates first control information including the first specifying information acquired by the specifying-information acquisition unit and the first setting information acquired by the first setting-information acquisition unit;
an attribute recognition unit that recognizes the attribute of the medium in a case where the second specifying information has been acquired by the specifying-information acquisition unit;
a second setting-information acquisition unit that acquires second setting information set for the attribute of the medium recognized by the attribute recognition unit, the second setting information being associated with the certain process;
a second generation unit that generates second control information including the second specifying information acquired by the specifying-information acquisition unit, the attribute of the medium recognized by the attribute recognition unit, and the second setting information acquired by the second setting-information acquisition unit; and
a transmission unit that transmits, to the printer, the print information acquired by the print information acquisition unit and the first control information generated by the first generation unit in a case where the first specifying information has been acquired by the specifying-information acquisition unit, and the print information acquired by the print information acquisition unit and the second control information generated by the second generation unit in a case where the second specifying information has been acquired by the specifying-information acquisition unit.

9. A non-transitory computer readable medium storing a program causing a computer to execute a process, the process comprising:
acquiring either of first specifying information and second specifying information, the first specifying information specifying a certain supply section that is to supply a medium to be used in a printing process from among a plurality of supply sections of a printer, the second specifying information specifying that the printer determine a supply section that is to supply the medium from among the plurality of supply sections on the basis of an attribute of the medium;
acquiring, in a case where the first specifying information has been acquired, first setting information associated with a certain process included in the printing process set for the certain supply section;
recognizing an attribute of the medium in a case where the second specifying information has been acquired;
acquiring second setting information set for the attribute of the recognized medium, the second setting information being associated with the certain process; and
performing control such that, in a case where the first specifying information has been acquired, the printing process is performed by the printer on the basis of the first setting information and, in a case where the second specifying information has been acquired, the printing process is performed by the printer on the basis of the second setting information.
